(19) United States
(12) Patent Application Publication
(10) Pub. No.: US 2012/0138543 A1
(43) Pub. Date: Jun. 7, 2012

(54) FLOCCULATION METHOD

(75) Inventors: Haihong LI, Edmonton (CA); Zhiang ZHOU, (US); Ross Sam CHOW, Sherwood Park (CA); Pablo CONTRERAS, Edmonton (CA)

(73) Assignee: ALBERTA INNOVATES - TECHNOLOGY FUTURES, Edmonton (CA)

(21) Appl. No.: 13/152,212

(22) Filed: Jun. 2, 2011

Related U.S. Application Data
(63) Continuation-in-part of application No. 12/858,758, filed on Aug. 18, 2010.

(51) Int. Cl. B01D 21/01; C02F 1/56

(52) U.S. Cl. 210/734; 210/729; 252/180; 252/181

(57) ABSTRACT

A charged particle polymer hybrid (CPPH) flocculant is taught, comprising sub-micron size charged particles and a polymer which has been polymerized in the presence of the charged particles wherein the intrinsic viscosity of the hybrid polymer flocculant is less than 930 ml/g. A method is provided for producing freely draining flocculated sediment from a suspension comprising finely divided solids in water. The method comprises dispersing, at increasing concentrations, a charged particle polymer hybrid (CPPH) flocculant into the suspension to determine a starting plateau concentration of CPPH flocculant above which concentration no further increase in the solids loading of the produced floccules is observed. Then, the concentration of dispersed CPPH flocculant in the suspension is maintained at or above the starting plateau concentration. A method is further provided for separating fine solids and water from a suspension comprising finely divided solids in water. The method involves dispersing, at increasing concentrations, a charged particle polymer hybrid (CPPH) flocculant into the suspension to determine a starting plateau concentration of CPPH flocculant above which concentration no further increase in the solids loading of the produced floccules is observed. Then, the concentration of dispersed CPPH flocculant in the suspension is maintained at or above the starting plateau concentration. The dispersion of CPPH flocculant in the suspension is agitated and the solid floccules are then separated from the supernatant liquid.

### RELATED APPLICATION

This application is a continuation-in-part (CIP) of U.S. patent application Ser. No. 12/858,758 filed Aug. 18, 2010 which is hereby incorporated by reference.

### FIELD OF THE INVENTION

This invention relates to a group of inorganic particle polymer hybrid flocculants for use in solid-liquid separation processes.

### BACKGROUND

Flocculation is a unit operation widely used for enhancing the separation of solids from liquid in aqueous suspensions. An organic polymeric flocculant, alone or in combination with inorganic coagulants, is normally added in the flocculation process. The most widely used flocculants are synthetic polyacrylamide (PAM)-based flocculants and derivatives thereof. Since its first use in the 1950s, PAM has found application in industries including mining and mineral processing, coal mining, pulp and paper, particularly de-inking, wastewater treatment, soil cleaning, waste oil recovery in oil and gas processing and treatment of tailings and wastewater in the oil and gas industry.

Treatment of oilsands tailings is a particularly troublesome environmental concern for the oil and gas industry, as the industry comes under increasing pressure to improve its environmental performance. Traditionally, oilsands tailings have been discharged directly from extraction to enormous tailings ponds where they are allowed to naturally settle. The fundamental drawback of this approach is the very large amount of time needed for fine tailings to settle. After a few years tailings mature into Matured Fine Tailings (MFT), having a solid loading of about content 30% by weight. MFT tend to resist further consolidation due to the high surface charges on the fine solids and residual bitumen droplets and their interactions. Tailings ponds currently in operation in the Alberta oilsands occupy a total area of more than 130 km². Given their scale, these open ponds pose significant risk of contamination to adjacent surface water resources.

The Alberta oilsands industry has been working to develop methods to eliminate or reduce the rate of accumulation of fine tailings. Since the 1990's paste technology, using commercial PAM alone or in combination with inorganic coagulants, has been tested at pilot and commercial scales. Typically, fine tailings slurry, dosed with a flocculating agent, is fed to a thickener vessel wherein the fine solids flocculate and settle. Fine tailings paste (thickened tailings) is discharged as the underflow from the thickener vessel. Warm process water can then be recycled more quickly from thickener overflow back into the extraction process, thereby saving significant amounts of thermal energy to heat process water. The fine tailings paste may be discharged to a tailings pond to allow time for further gradual dewatering and consolidation. Alternatively, the fine tailings paste may be subjected to further rapid dewatering as, for example, by centrifugation. In either case it is highly desirable that the fine tailings paste, which comprises flocculated fine solids and associated water, achieves high solids content when formed and is amenable to subsequent further dewatering and consolidation. The ultimate objective is that the paste be converted into compacted fine solids having at least a minimum solids content that corresponds to the minimum load bearing capacity to support construction traffic and enable final deposition in a reclamation operation.

To date, pilot scale testing with a combination of thickener technology and centrifugation have produced the most promising results in terms of solids loading, achieving solids loadings from 50% to 60% by weight. However, this is still short of the desired solids content for reclamation use. Furthermore, centrifugation is a high energy separation process. The PAM-based flocculants that are currently most commonly used in commercial practice possess certain shortcomings, including:
linear PAM, having a high molecular mass, may easily be broken down into smaller, shorter molecules of polymer under mechanical mixing and turbulent flow conditions, reducing its efficiency.
ionic PAM chains become stretched by incorporation of charged anionic or cationic monomer sites that repel each other along the length of the polymer. While the presence of these charged sites on the PAM chains makes them more effective in capturing dispersed solid particles, they also limit how closely the captured particles can be drawn together. This results in loose, fragile floccules that retain large amounts of water.
PAM can only operate within a relatively narrow concentration range, outside of which its flocculating performance deteriorates, resulting in process control difficulties in large scale industrial operations. Over-dosing can result in curling of PAM molecules and associated loss of effectiveness, or results in dispersing rather than flocculating the suspended solid particles.

To improve solid-liquid separation performance using PAM, research has been carried out since the 1990s. A number of combinations of PAM, both ionic and non-ionic, in a mixture with highly charged particles of nano- to micro-particle size were examined. Tested particles include both organic polymers and inorganic minerals, with zeta potential of greater than 30 to 40 mV under natural conditions. Published results showed a marked improvement in flocculation performance using the combination of PAM and cationic charged micro-particles, over use of either component on its own. It is postulated that the underlying mechanism for the improvement is the enhanced coagulation of positively charged micro-particles with negatively charged fine solids, forming enlarged floccules with PAM as bridges. However, there is no reported practical application in solid-liquid separation, possibly due to the high cost of manufacturing charged micro-particles.

Efforts to develop hybrid organic-inorganic polymeric flocculants were also pursued in China in the early 2000's, derived in part from research on synthesizing hybrid organic-inorganic composite materials. These development efforts focused on synthesising various polymer hybrid, including palygorskite-polyacrylamide (PGS-PAM), aluminum hydroxide-PAM (Al-PAM), and a thermal-sensitive poly (N-isopropyl acrylamide) (PNIPAM). These hybrid flocculants have been tested within similar concentration ranges as that of PAM alone, to avoid the ill-effects of overdosing.

Further development of hybrid flocculants is greatly needed to achieve an effective and cost effective means of separation of fine solids from liquids suspensions at an industrial scale, including oilsands tailings suspensions.

### SUMMARY

A charged particle polymer hybrid (CPPH) flocculant is taught, comprising sub-micron size charged particles and a polymer which has been polymerized in the presence of the charged particles wherein the intrinsic viscosity of the hybrid polymer flocculant is less than 930 ml/g.

A method is provided for producing freely draining flocculated sediment from a suspension comprising finely divided solids in water. The method comprises dispersing, at increasing concentrations, the charged particle polymer hybrid (CPPH) flocculant described in claim 1 into the suspension to determine a starting plateau concentration of CPPH flocculant above which concentration no further increase in the solids loading of the produced floccules is observed. Then, the concentration of dispersed CPPH flocculant in the suspension is maintained at or above the starting plateau concentration.

A method is further provided for separating fine solids and water from a suspension comprising finely divided solids in water. The method involves dispersing, at increasing concentrations, a charged particle polymer hybrid (CPPH) flocculant into the suspension to determine a starting plateau concentration of CPPH flocculant above which concentration no further increase in the solids loading of the produced floccules is observed. Then, the concentration of dispersed CPPH flocculant in the suspension is maintained at or above the starting plateau concentration. The dispersion of CPPH flocculant in the suspension is agitated and the solid floccules are then separated from the supernatant liquid.

### BRIEF DESCRIPTION OF THE DRAWINGS

The present invention will now be described in greater detail, with reference to the following drawings, in which:

FIG. 1 illustrates floccule formation and form as a result of increasing metal-hydroxide polymer hybrid (MhPH) flocculant dosing concentration;

FIG. 2 shows the sediment produced from flocculation of oilsands tailings with Fe(OH)₃-PAM at different flocculant dosage concentrations;

FIG. 3 shows the sediment produced from flocculation of oilsands tailings with Al(OH)₃-PAM at different flocculant dosage concentrations;

FIG. 4 is a plot of solids loading in the flocculated sediment as a function of flocculant concentration for Fe(OH)₃-PAM tested on an oilsands tailings suspension;

FIG. 5 is a plot of initial rate as a function of flocculant concentration for Al(OH)₃-PAM tested on an oilsands tailings suspension;

FIG. 6 is a plot of initial settling rate as a function of flocculant concentration for two flocculants: PAM and Al(OH)₃-PAM tested on a kaolinite suspension.

### DESCRIPTION OF THE INVENTION

The present invention relates to a group of charged particle polymer hybrid (CPPH) flocculants and their application in the separation of finely dispersed solids from aqueous suspensions. More preferably, the present invention provides novel metal-hydroxide polymer hybrid (MhPH) flocculants, a subset of CPPPH flocculants, for the treatment of oilsands tailings. The inventors have further investigated the impact of intrinsic viscosity and dosing concentrations of the present MhPH flocculants. The present group of flocculants was tested on kaolinite and oilsands clay and fine tailings suspensions, at a variety of dosing concentrations.

Preferably the inorganic particles comprise iron-hydroxide particles or aluminum-hydroxide particles. Preferably, the polymer is PAM. CPPH flocculants are effective over a wide range of dosage rates and, compared to conventional polymer flocculants, are significantly less sensitive to over-dosing

The present CPPH flocculants comprise sub-micron size charged particles and a polymer which has been polymerized in the presence of the charged particles. When solid particles are dispersed in water, they acquire electrical charges, due to either dissolution of the solid surfaces, ionization of surface groups, adsorption of ions from the water on the surfaces, or substitution of ions in the lattice of the solids, etc. Although the whole suspension system is in electroneutrality, a difference in charge exists between the stationary layer (or plane of shear) of water attached to the dispersed particle and the bulk water. The extent of this difference is normally called zeta-potential. The polarity of zeta potential can be evaluated based on the determination of the iso-electric point (IEP) or point of zero change (PZC), where the net surface charge is zero at a given solution pH, pH_{pzc}, which varies with different types of dispersed solids. Therefore, by changing solution pH, the solids can be positively charged at solution pH less than pH_{pzc}, or negatively charged at solution pH greater than pH_{pzc}. Most mineral particles, for example clays, are negatively charged under natural conditions. For Al(OH)₃ the PZC occurs at pH between 9 and 10. The sub-micron sized particles can be metal oxides or metal hydroxides. Preferably the sub-micron sized charged particles are positively charged metal-hydroxide particles and the resulting hybrid formed is a metal-hydroxide polymer hybrid (MhPH) flocculant. Further preferably, but not necessarily, the polymer can be polyacrylamide (PAM) or other commercially available polymers that are known in the art to be useful as flocculants. It is understood by the inventors that ionic bonding links PAM to the surface of the positively charged metal-hydroxide particles. An exemplary MhPH flocculant is illustrated below using Al(OH)₃ or Fe(OH)₃, and showing them to have a positive charge.

The metal is preferably, but not necessarily, a transition metal or a multivalent metal when ionized. More preferably, the metal can be aluminum or iron and the metal-hydroxides are most preferably aluminum hydroxide (Al(OH)₃) or iron hydroxide (Fe(OH)₃). Alternatively, the hydroxides may be mixed metal hydroxides.

Most preferably, but not necessarily, the flocculant can be a synthesized inorganic-organic hybrid Al(OH)₃-PAM or Fe(OH)₃-PAM flocculant.

The present inventors have observed a surprising connection between the intrinsic viscosity, and the observed performance of the present CPPH flocculants in the separation of finely dispersed solids from aqueous suspensions. The intrinsic viscosity of the CPPH flocculants is determined primarily by the length and shape of the polymer branches attached to the inorganic core particles and therefore serves as a useful proxy for the size and shape characteristics of individual hybrid flocculant particles. It is hypothesized that the polymer branches of individual hybrid flocculant particles must extend far enough from the charged inorganic cores such that their probability of contacting and attaching to suspended particles is high while at the same the polymer branches must not be so large as to inhibit attached suspended particles from being drawn close to the inorganic core particles by electrostatic attraction.

Preferably the intrinsic viscosity of the CPPH flocculant is less than 930 ml/g. More preferably, the intrinsic viscosity of the CPPH flocculant is from 210 ml/g to 930 ml/g. Most preferably, the intrinsic viscosity is from 470 ml/g to 930 ml/g.

For a given size distribution and loading of charged inorganic core particles the intrinsic viscosity of a CPPH flocculant can be varied by controlling the polymerization reaction during hybrid synthesis. There are several known techniques in the art by which this may be achieved, including but not limited to varying and controlling monomer concentration, initiator concentration, polymerization temperature, and chain-transfer agents.

Preferably, varying the concentration of free radical initiator can proportionally vary the intrinsic viscosity of the resulting hybrid flocculant. The present inventors varied the range of free radical initiator used from 100% to 500% of that used in the synthesis of prior art inorganic particle polymer hybrid flocculants. Higher concentrations of free radical initiator result in lower intrinsic viscosity for the resulting hybrid flocculants. For example, as shown in the following table, by doubling the free radical initiator concentration used in the synthesis of prior art aluminum-hydroxide-PAM hybrid flocculants the intrinsic viscosity is reduced by about 40% to produce a CPPH flocculant of the present invention.

| | | | | Current |
|---|---|---|---|---|
| | Prior Art | | | Invention |
| Initiator concen- | 0.0667 | 0.0667 | 0.0667 | 0.133 |
| tration (wt. | | | | |
| initiator/ | | | | |
| wt. of monomer) | | | | |
| Intrinsic viscos- | 1,120 | 1,146 | 1,230 | 766 |
| ity (ml/g) | | | | |

Note:
Prior art values for Yang et al. (2004)

It is understood by the present inventors that optimum intrinsic viscosity of the present CPPH flocculants correlates strongly with flocculation performance. If the intrinsic viscosity is too low, indicative of short or entangled polymer chains and branches, the effectiveness of the hybrid flocculant in capturing suspended fine particles is diminished. Conversely, high intrinsic viscosity is understood to indicate high average length for the polymer branches attached to the charged inorganic core particles, which, beyond an upper limit, acts to inhibit the electrostatic attraction between captured suspended particles and the charged inorganic core of the flocculant.

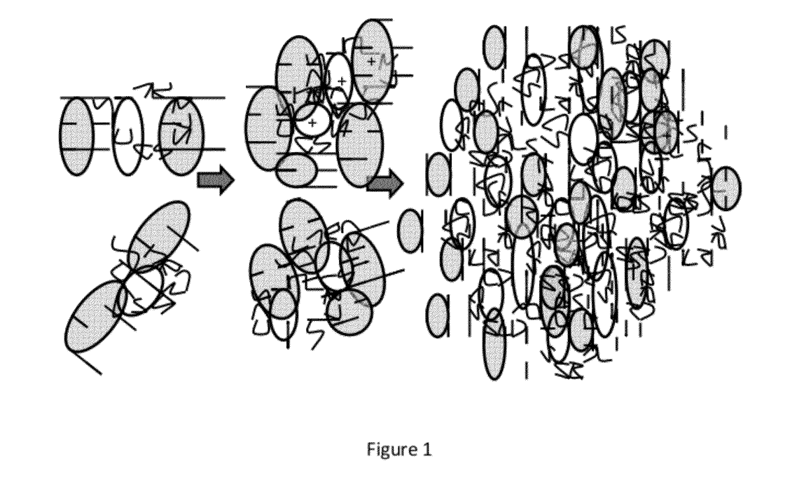

The present group of CPPH flocculants and, more preferably MhPH flocculants, have shown good flocculating results and excellent dewatering results for a number of types of suspensions. As hypothesized above, these results are thought to be due to a more complete exploitation, relative to prior art inorganic particle polymer hybrid flocculants, of the attractive electrostatic forces between the charged cores in the hybrid flocculant particles and the oppositely charged solids in suspension, and correlate to the particular range of intrinsic viscosity of the presently synthesized hybrid flocculants. In the case of MhPH flocculants, electrostatic attraction commonly, but not always, exists between the positively charged metal-hydroxide cores and the negatively charged fine solids. When effectively exploited, these inter-particle attractive forces act to squeeze out entrapped water between fine solid particles, thereby producing compacted solid agglomerates, called floccules, with high solids contents. The mechanism is illustrated for clarity below and also in FIG. 1.

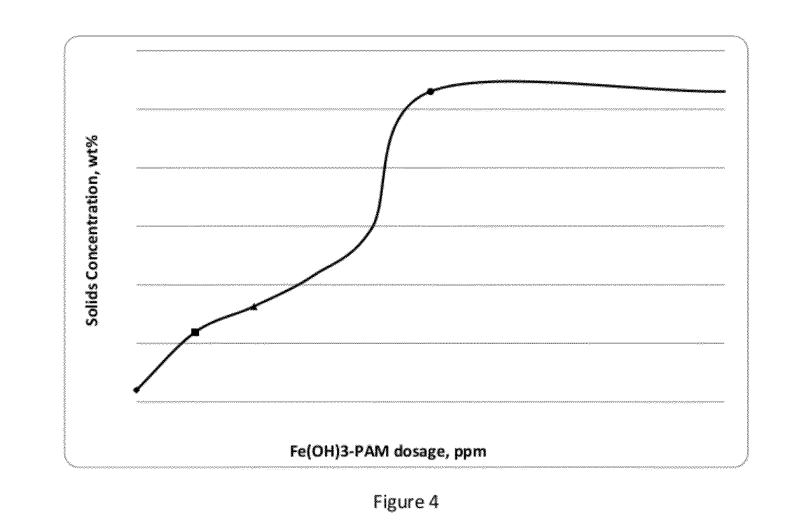

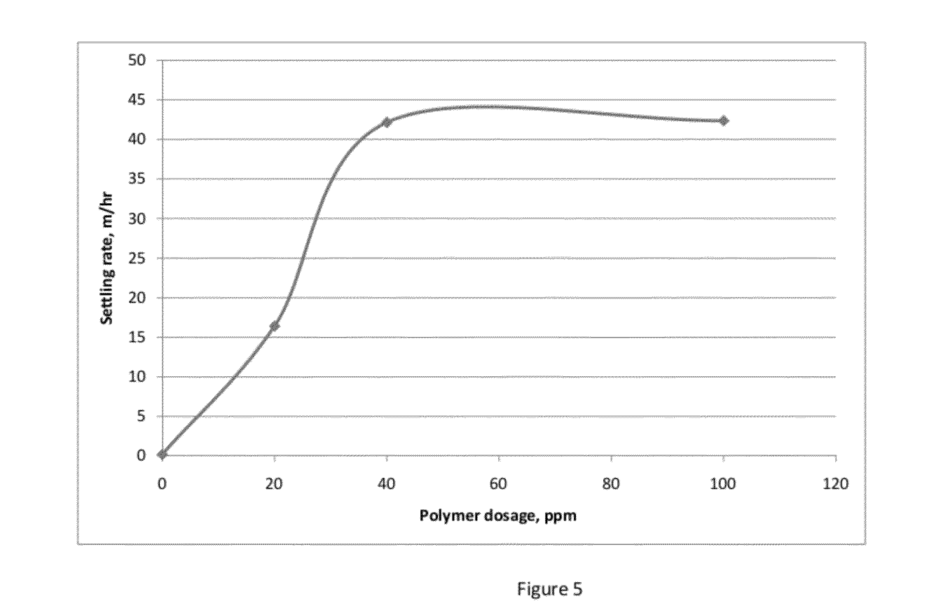

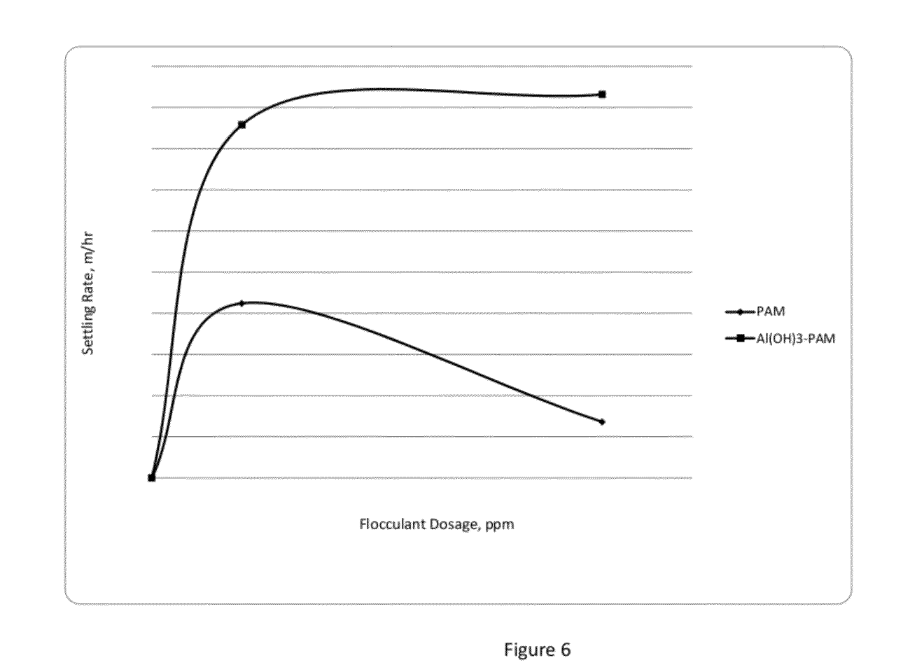

In testing MHP flocculants on kaolinite and oilsands fine tailings suspensions, the inventors steadily increased dosing concentrations of the CPPH flocculant. Dosing concentration for the purposes of the present invention is described in parts per million (ppm), which is defined as milligrams of flocculant per litre of suspension. Initial settling rates and solids loading in the flocculated sediments increased with increasing dosing concentration and then plateaued. By plotting the solids loading (or initial settling rate) of the flocculated sediment against CPPH flocculant dosing concentration, as for Fe(OH)3-PAM of the present invention in FIG. 4 or for Al(OH)3-PAM of the present invention in FIG. 5 and FIG. 6, a starting plateau concentration may be determined. Herein, this starting plateau concentration is defined to be approximately that dosing concentration of CPPH flocculant above which concentration no further increase in the solids loading of the produced flocculated sediment is observed. For the model suspension systems tested, MhPH flocculants of the present invention when used in concentrations at or above the starting plateau concentration produced floccules with solids loading above 45% by weight, or above 18% by volume, when converted using an estimated specific gravity of 2.5 for silica based solids

It was found that CPPH dosing concentrations at or above the starting plateau concentration produce flocculated sediment having high permeability and showing excellent dewatering ability. Preferably, the minimum permeability of the flocculated sediment resulting from the present methods is 1 Darcy. More preferably, a minimum permeability of 10 Darcy is achieved and even further preferably a minimum permeability of 100 Darcy is achieved. No ill-effects, such as those associated with overdosing of conventional polymer flocculants, were found for the present group of CCPH flocculants.

It was noted that the response to flocculant dosage concentration for the present CPPH flocculants is different from that of either conventional polymer flocculants or prior art inorganic particle polymer hybrid flocculants. Collectively, the prior art flocculants exhibit the same typical behaviour. Starting at low flocculant dosage concentration, initial settling rate (and solids loading in the flocculated sediment) gradually increases with increasing flocculant dosage, reaches a peak, falls off gradually and may ultimately enter a regime where the flocculant acts to stabilize rather than destabilize the target suspension. The characteristic response of polymer flocculants to dosage concentration is illustrated by the curve for PAM in FIGS. 6. As reported by Yang et al. the initial settling rate for both prior art Al(OH)3-PAM hybrid flocculant and a benchmark PAM dropped off as flocculant dosage increased from 4 ppm to 6 ppm, indicating that for the test suspension used the peak settling rate for both flocculants occurred in the range between 4 ppm and 6 ppm.

The reason for the absence of observable over-dosing behaviour with the present CPPH flocculants is believed to be due to the unique structure of the individual hybrid flocculant particles which enables captured suspended particles to be drawn close enough to the charged core of a CPPH flocculant particle that strong electrostatic attraction becomes the dominant binding force. Since electrostatic attractive forces are much stronger than the weak binding forces between polymer and suspended particles, surplus polymer is expelled from the space between the charged core and the captured suspended particle when the CPPH bound floccules are formed. Also, once formed, CPPH bound floccules are immune to ingress of polymer that could, as is the case in over dosing with conventional polymer flocculants, coat the surface of suspended particles and act to disperse rather that agglomerate them.

The method of the present invention comprises dispersing, at increasing concentrations, a CPPH flocculant, for which the intrinsic viscosity ranges from 210 ml/g to 930 ml/g, into a target suspension to determine a starting plateau concentration of CPPH flocculant above which concentration no further increase in the solids loading of the produced flocculated sediment is observed. Then, the concentration of dispersed CPPH flocculant in the suspension is maintained at or above the starting plateau concentration. Preferably the concentration of dispersed CPPH flocculant is maintained at from 1.2 to 3 times the starting plateau concentration.

The starting plateau concentration of CPPH flocculant to achieve the highest possible solids loading floccules also depends on the concentration and size of the suspended solid particles. The degree of agitation applied during flocculation is a further factor, wherein, up to a certain point, increased agitation results in a reduction in the starting plateau concentration. Very small scale testing, in graduated cylinders with agitation provided by shaking, often produced a single large high solids floccule. Beaker scale testing with an impeller type stirrer, in some cases inserted to the bottom and imbedded in the flocculated sediment, resulted in sediment comprising largely discrete high solids floccules. In both cases, the supernatant was readily separated from the sediment, either by decanting or by allowing the water to drain away through the flocculated sediment. In a preferred embodiment, the dispersion of CPPH flocculant in the suspension is accomplished by one or more methods including stirring, mixing, mechanical agitation and injection mixing.

The residence time for flocculation with the present group of flocculants and flocculant dosage regime is very fast, measured in seconds. Likewise, the settling rate for the high solids floccules produced is very fast ranging from 12 mm/s to 25 mm/s on clay and mineral suspensions. Also, the turbidity of the supernatant is very low, indicating that the residual solids content of the supernatant is very low, which will contribute to reduced treatment costs and greater flexibility for reuse or disposal of the recovered water.

Settling rate, floccule quality and supernatant clarity were also not found to diminish when MhHP flocculants were added at dosages higher than the starting plateau concentration level, showing good performance even in what have previously been considered over-dosing conditions. Achieving excellent flocculating results over a broad range of flocculant dosage concentration can be very attractive in industrial scale operations where the composition of the target suspension varies widely, as for example in oilsands processing, since this eliminates the need to closely monitor and control flocculant dosage.

Furthermore, there was no detectable carry-over of metals from the MhHP flocculants to the supernatant, even at dosage rates significantly above the starting plateau concentration.

For the model suspensions tested, the method was found to produce compacted floccules having high solids content. This is positively correlated with the mechanical robustness of the floccules and, in turn, with the formation of high permeability flocculated sediment that can be readily dewatered. Dewatering may be accomplished by commonly known means including, but not limited to screening, filtering or simply by letting the supernatant liquid drain away through the sediment.

Preliminary results from drained consolidation tests of the flocculated sediments of the present invention indicate that these flocculated sediments are amenable to further compaction and dewatering.

The present CPPH flocculants showed good results on oilsands tailings and kaolinite suspension, but can also be used in a number of separation applications including, but not limited to mining and mineral processing, coal mining, pulp and paper, particularly de-inking, water treatment, wastewater treatment, soil cleaning, waste oil recovery in oil and gas processing and treatment of tailings and wastewater in oil and gas production and processing.

### EXAMPLES

The following examples serve merely to further illustrate embodiments of the present invention, without limiting the scope thereof, which is defined only by the claims.

### Example 1

1. Making MhPH

Two MhPHs were synthesized with different inorganic core particles: Al(OH)₃-PAM and Fe(OH)₃-PAM. Al(OH)₃-PAM was made by following a modification of the procedure published by Yang et al. (2004). Fe(OH)₃-PAM was made following a procedure similar to that used for Al(OH)₃-PAM.

MhPH Synthesis Consists of Three Steps:

a. Preparation of a metal-hydroxide colloidal solution comprising sub-micron particles of metal-hydroxide. Al(OH)₃ and Fe(OH)₃ colloid solutions were prepared by a slow and dropwise addition of an ammonium carbonate solution into a metal chloride solution under agitation at room temperature (22° C.). The following reaction occurred (Li et al., 2008):

2AlCl₃+3(NH₄)2CO₃+3H₂O=2Al(OH)₃+6(NH₄)Cl+3CO₂

Agitation aids in obtaining a metal-hydroxide colloidal solution with uniform sub-micron particulate size.

b. Acrylamide monomer is dissolved in the metal-hydroxide colloidal solution and polymerized by the addition of (NH4)₂S₂O₈—NaHSO₃ as an initiator. Typically, 0.6-1.5 g of 0.075 wt % NaHSO₃ and 0.15 wt % (NH₄)₂S₂O₈ was added to 30 ml of metal-hydroxide colloidal solution containing 4.5 g acrylamide in a 2000 ml flask. Nitrogen gas was introduced to the flask for 30 minutes before addition of the initiator. After that, the flask was sealed and polymerization proceeded for 8 h at 40° C.

c. Product separation and purification. The final step was to extract and purify the reaction product by dissolving the product in deionised water, precipitating impurities, and extracting pure MHP with an acetone solution. This procedure can be repeated twice to obtain pure product. Then the extracted material was dried at 50° C. in a vacuum oven to obtain the final MhPH product.

d. Intrinsic viscosity. Viscosity measurements were conducted with an Ubbelohde viscometer at 30° C. Intrinsic viscosity for the MhPH samples synthesized ranged from 210 ml/g to 930 ml/g

2. Suspension Creation

The suspensions used for testing MhHP were prepared by mixing fine solid samples with deionised (DI) or process water at specific solids concentrations. Two solids samples were used for the MHP testing:
Pure kaolinite sample from Dry Branch Kaolin Company with a density of 2.5 g/cm³, and median particle size of 0.2 micron. The solid slurry was prepared with DI water having 1 wt % solids and a pH adjusted to 9.0 with NaOH.
Two oilsands interbedded clay samples were obtained and had the following properties:

| # Sample | Density | Fines (−44 μm) % | Bitumen content % |
|---|---|---|---|
| Clay 1 | 2.53 | 53.14 | 4.23 |
| Clay 2 | 2.58 | 80.41 | 1.57 |

The suspension was prepared by mixing oil sands clay with process water, containing about 13.1 ppm Ca⁺⁺ and 9.2 ppm Mg⁺⁺ and allowing 10 minutes for the coarser particles to settle to obtain, as the supernatant, a suspension at pH 8.3 containing 1 wt % suspended solids with a particle size less than 10 microns.

3. Sedimentation Experiments

The fine solid suspension and the MhPH flocculant at the desired dosing concentration were mixed in a 50 ml cylinder for the settling test. The cylinder was sealed with a paraffin wax film and then shaken upside down several times to mix the suspension and MHP flocculant and then placed on a solid plate to begin the settling test. A Canon G10 camera mounted on a tripod was used to take pictures at predetermined time intervals to record the descent of the solids/liquid interface, also called the mudline, in the cylinder. The image data was analysed and transferred to a settling plot of supernatant layer height vs. settling time, which was used to determine the initial settling rate (mm/second) from the slope of the initial linear portion of the plot. All tests were conducted at room temperature of 22° C.

4. Estimation of Solid Content in Sediment was Made by Dividing the Mass of Dry Solid by the Mass of Wet, Free-Drained Sediment, and Converting to a Volume Percent.
The wet, free-drained sediment is removed from the suspension and weighed to obtain the mass of free-drained, wet sediment and then is heated in an oven (110° C.) to dry. The dry solid sediment is weighed to obtain the mass of dry solid. The weight percent is converted to a volume percent by dividing by the known densities of the sediment and of water.

Results:

a. Floccule and Supernatant Quality:

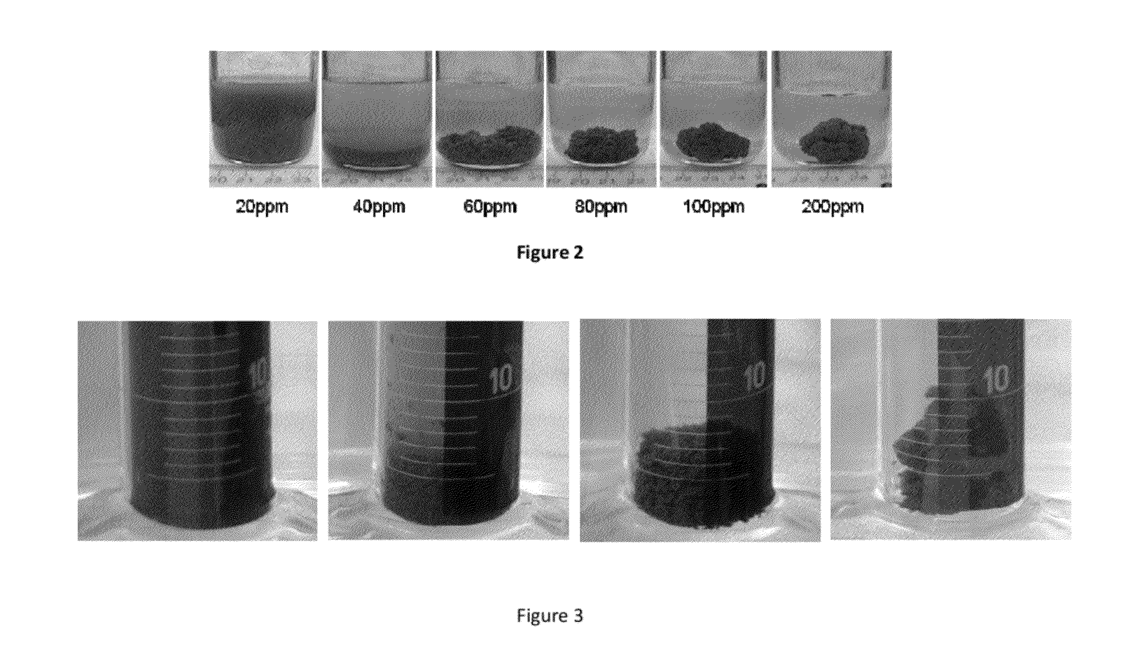

FIGS. 2 and 3 illustrate the sediments produced by using Fe(OH)₃-PAM and Al(OH)₃-PAM flocculants of the present invention at varying concentrations. From FIGS. 2 and 3 it is evident to the naked eye that the form of the sediment produced varies with flocculant dosing concentration, at least until some threshold concentration is reached. Herein, such threshold concentration is referred to as the starting plateau concentration.

b. Solids Content in Drained Sediment:

FIG. 4 relates to the same experimental data set as FIG. 2 and plots the solids loading in the drained sediment resulting from flocculation of the sample suspension with Fe(OH)₃-PAM. Referring to FIG. 4, the solids loading in the drained sediment produced at a flocculant concentration of 60 ppm is only 21.5% by weight or 8.6% by volume. By contrast, at a flocculant concentration of 100 ppm the solid loading in the drained flocculated sediments is 53% by weight or 21.2% by volume. It is clear that the starting plateau concentration, lies at a value between 80 ppm and 100 ppm for the present sample suspension and hybrid flocculant tested. Sediment with exactly the same solids loading is produced at a flocculant concentration of 200 ppm, which is at least 200% of the starting plateau concentration.

A further observation is that large floccules may be produced at flocculant concentrations below the starting plateau concentration, as can be seen in FIG. 2 for a flocculant concentration of 80 ppm, which yields a solids loading in the drained flocculated sediment of only 29.6% by weight or 11.84% by volume.

c. Settling Rates:

FIG. 5 plots settling rates of flocculated sediment resulting from flocculation of the present oilsands sample suspensions with Al(OH)₃-PAM flocculant of the present invention. In this case the starting plateau concentration is approximately 40 ppm.

FIG. 6 compares settling rates for a kaolinite suspension treated with Al(OH)₃-PAM of the present invention and a benchmark PAM respectively. Again, the hybrid metal-polymer flocculant performs much better than PAM. In this Figure, the settling rate for PAM peaks and thereafter decreases as dosage increases. By contrast, the curve for Al(OH)₃-PAM of the present invention reaches a plateau with increasing dosage and, at approximately 500% of the starting plateau dosage concentration still shows no overdosing effects.

### Example 2

1. Making MhPH—The MhPH Flocculant was Prepared in the Same Manner as Example 1 Above.

2. Suspensions Tested—The Following Suspensions were Tested:

| | | % Solids in | |
|---|---|---|---|
| Suspension | | suspension | Fines content |
| Sample | Origin of fine solids | (% wt.) | (% < 44 micron) |
| (a) | Fresh tailings from lab- | 10 | 18% |
| | scale bitumen extraction | | |
| (b) | Oilsands fines 1 | 10 | 53% |
| (c) | Oilsands fines 2 | 10 | 80% |

3. Test Method:

The following suspensions were flocculated with the following flocculants:

| | Suspension | | Flocculant dosage (ppm, |
|---|---|---|---|
| Test No. | Sample | Flocculant type | whole suspension basis) |
| 1 | (a) | PAM | 100 |
| 2 | (a) | Fe(OH)₃-PAM | 100 |
| 3 | (b) | PAM | 200 |
| 4 | (b) | Fe(OH)₃-PAM | 150 |
| 5 | (c) | PAM | 300 |
| 6 | (c) | Fe(OH)₃-PAM | 300 |

PAM denotes the commercial product designated as Magnafloc 1011, which is a high-molecular-weight medium-charge-density anionic flocculant, supplied by Ciba Specialty Chemicals Ltd. Magnafloc 1011 is reported to be a particularly good flocculant for use with oilsands fine tailings. (Cymerman, G.; Kwong, T.; Lord, E.; Hamza, H.; Xu, Y. In Polymers in Mineral Processing; J. S. Laskowski, Ed.; 38th Annual Conference of Metallurgists of CIM: Quebec, 1999; pp 605-619.)

a. The suspensions were conditioned with the added MhPH or PAM flocculant in a 1000 ml beaker and agitated at 300-450 rpm;

b. The conditioned slurry was then poured into a transparent tube with 1D6.35 cm, a screen with an average pore size of 0.6 mm to retain flocculated sediment, a conical tapered section below the screen, and a valve below the tapered section to shut off or allow flow through the sediment layer. This apparatus was first tested with clean water and no sediment layer to determine the extent of the maximum flow rate for the apparatus itself. This was measured to be 166.3 ml/sec.;

c. Settling tests were conducted, using a digital camera, controlled by a computer program to take pictures at 10 second intervals for 5 minutes.

d. A valve at the bottom of the tube was opened to allow for water drainage from the bottom of the tube to measure both the drainage rate and the amount of water removed, which also provides the amount of water remaining since the total starting amount of water is known. This approach worked well for the flocculated sediments with good drainage characteristics, tests 4 and 6. However, for tests 1, 2, 3 and 5 only a small fraction of the total water drained through the sediment. For tests 1, 2, 3 and 5 the wet sediment was weighed after siphoning off as much water as possible and again after drying to determine the percent solids in the equivalent of the free drained sediment from tests 4 and 6.

e. Permeability of the sediment layer was determined in the same apparatus as used for the drainage tests referred to above. The volume of water flowing through the sediment layer was measured while maintaining a constant head of (potable Edmonton) water above the sediment layer. The measured flow rate stabilized within 10 seconds and the stabilized flow rate was used to calculate permeability. The hydrostatic head provided by the experimental apparatus was about 47 cm, which was assessed to be representative of the upper limits of what might be expected in industrial screening or filtration practice. This is an important consideration since above some threshold hydrostatic pressure the sediment bed may undergo accelerated consolidation and consequently a rapid reduction in its permeability. It was determined by observation that when a sediment layer was present, the conical section and tubing downstream from the screen were at all times flowing only partially full. Also, the measured flow rates through the apparatus when a sediment layer was present were, even for the most permeable sediments, only a fraction of those for the apparatus with no sediment layer. Therefore, for the purpose of determining the pressure drop across the sediment layer it was assumed that the pressure at the upstream side of the screen was atmospheric. Consequently the pressure drop across the sediment layer was equal to the hydrostatic pressure of the constant column of water maintained above the sediment layer. Permeability was then determined using the Darcy equation:

k=μ.L.Q/ρ.g.h.A, where:
k is the permeability of the sediment (m²);
μ is the dynamic viscosity of the fluid (Pa·s);
L is the measured thickness of the sediment layer (m);
Q is the measured flow rate through the sediment layer (m³/sec); and
ρ is the density of the fluid (Kg/m³)
g is gravitational acceleration (m/s²)
h is the measured height of water above the sediment layer (m)
A is the cross sectional area of the sediment layer (m²)

The value used for the viscosity of the potable water was 0.00089 Pa·s.

f. Compressibility was tested at 5 different pressures, each for 5 minutes. The maximum applied pressure was 28.5 kPa, which was the upper limit achievable for the experimental setup used. Discharged water is measured and recorded online by a computer program. The flocculated sediment was then removed and weighed both wet and after drying in an oven for solid content calculation.

g. Turbidity of the filtrate and of the starting process water was measured using a HACH Model 2100AN Laboratory Turbidimeter.

h. The filtrate was analysed for dissolved calcium, magnesium and iron and compared to concentrations of these metals in the starting process water.

4. Results: The Results are Presented in the Following Tables.

| | Initial | Wt. % solids | Drainage | | Permeability | Wt. % solids |
|---|---|---|---|---|---|---|
| Test | settling rate | in drained | through | Time to zero | of flocculated | in drained |
| No | (mm/sec) | sediment | sediment (ml) | drainage (sec) | sediment (Darcy) | compacted sediment |
| 1 | 6.2 | 65.3 | 4.3 | 30 | na | na |
| 2 | 11.0 | 70.2 | 119.2 | 130 | na | na |
| 3 | 4.5 | 43.3 | 11.1 | 60 | na | na |
| 4 | 16.2 | 52.3 | 945.0 | 31 | 118.6 | 75.1 |
| 5 | 4.0 | 38.2 | 11.7 | 60 | na | na |
| 6 | 25.0 | 49.3 | 916.0 | 31 | 125.5 | 69.1 |

| | Turbidity | Ca²⁺ | Mg²⁺ | Fe³⁺ |
|---|---|---|---|---|
| Test No | (NTU) | (mg/l) | (mg/l) | (mg/l) |
| Process water | 12 | 13.1 | 9.2 | <0.01 |
| 1 | 80 | na | na | na |
| 2 | 4 | 16.2 | 11.3 | <0.01 |
| 3 | 1,418 | 8.7 | 6.3 | <0.01 |
| 4 | 23 | 9.8 | 7.3 | <0.01 |
| 5 | 1,237 | 6.3 | 4.6 | <0.01 |
| 6 | 28 | 6.9 | 5.1 | <0.01 |

a. Settling Rates:

Settling rates for the present MhPH flocculants were much faster than that of flocculation using the PAM product. Further, for the MhPH flocculants and dosages used in these tests the settling rate increases as the content of finer particles, i.e. less than 44 microns in size, increases. The increased settling rates demonstrated for MhPH flocculants indicate the potential of MhPH flocculants to increase the throughput capacity of thickener vessels, thus improving their economic performance.

b. Solids Content in the Drained Sediment

With MhPH and suspensions with an adequate fraction of fine particles the water drained readily through and from the flocculated sediment. This was not the case for any of the tests (numbers 1, 3 and 5) using the PAM flocculant and also for the MhPH test (number 2) where the suspension had a low fraction of fine particles. Despite the uncertainties associated with the different approaches to removal of free water it can be seen that the solids content, here defined as the mass of solids expressed as a percentage of the mass of solids plus the mass of associated water of the resulting dewatered (drained or siphoned) sediment, is systematically higher for the MhPH tests

c. Permeability of Flocculated Sediment

Permeability of the flocculated sediment was greatly improved by use of the present MhPH flocculants provided the treated suspension contained an adequate fraction of fine (less than 2 micron) particles. It was not possible to determine permeability for tests 1, 2, 3 and 5 because there was insufficient drainage through the flocculated sediment. Increased permeability enables faster and more complete separation of supernatant from the flocculated sediment with less energy input.

d. Compressibility of Flocculated Sediment

Compressibility of flocculated sediment, under free draining conditions, was examined for both the 53%<44 micron MhPH sample and the 80%<44 micron MhPH sample, tests 4 and 6. The solids content after compression at a maximum applied pressure of 28.5 kPa increased from 52% to 75% for test 4 and from 49% to 69% for test 6. These results indicate that MhPH flocculated sediments are amenable to further dewatering in response to applied compressive loads.

e. Supernatant Quality

The quality of supernatant drained from the flocculated sediment was examined and its turbidity measured. Clear, low turbidity supernatant is desirable to minimize the amount of water treatment required and to potentially recycle the supernatant stream back into the process. Turbidity is reported in the tabulated results, from which it can be seen that flocculation with the present group of MhPH flocculants produced a clearer supernatant stream containing very little suspended particles, when compared with the higher turbidity seen in supernatant resulting from suspension flocculation with PAM as the flocculant.

f. Concentration of Dissolved Metals

With the exception of the anomalous results for Test number 2, it can be seen that both the PAM and Fe(OH)₃-PAM hybrid flocculants were effective in reducing the concentration of both Ca²⁺ and Mg²⁺³⁰ compared to the starting process water. Looking at the measured concentrations of Fe³⁺ it is clear that there was no measurable loss of iron from the hybrid flocculant to the separated water.

1. A charged particle polymer hybrid (CPPH) flocculant, comprising sub-micron size charged particles and a polymer which has been polymerized in the presence of the charged particles wherein the intrinsic viscosity of the hybrid polymer flocculant is less than 930 ml/g.

2. The charged particle polymer hybrid flocculant of claim 1, having an intrinsic viscosity of from 210 ml/g to 930 ml/g.

3. The charged particle polymer hybrid flocculant of claim 2, having an intrinsic viscosity of from 470 ml/g to 930 ml/g.

4. The charged particle polymer hybrid flocculant of claim 1, wherein the intrinsic viscosity is controlled by varying one or more factors selected from the group consisting of monomer concentration, initiator concentration, polymerization temperature and chain-transfer agents.

5. The charged particle polymer hybrid flocculant of claim 4, wherein the intrinsic viscosity is controlled by varying initiator concentration during polymerization.

6. The charged particle polymer hybrid flocculant of claim 1, wherein the charged particles are sub-micron sized metal-hydroxide particles and the CPPH flocculant is a metal-hydroxide polymer hybrid (MhPH) flocculant.

7. The charged particle polymer hybrid flocculant of claim 1, wherein the charged particles are sub-micron sized mixed metal-hydroxide particles and the CPPH flocculant is a mixed metal-hydroxide polymer hybrid flocculant.

8. The charged particle polymer hybrid flocculant of claim 6, wherein the metal is a transition metal or a metal with multivalence when ionized.

9. The charged particle polymer hybrid flocculant of claim 6, wherein the metal is aluminum.

10. The charged particle polymer hybrid flocculant of claim 6, wherein the metal is iron.

11. The charged particle polymer hybrid flocculant of claim 1, wherein the polymer is polyacrylamide.

12. The charged particle polymer hybrid flocculant of claim 6, wherein the MhPH flocculant is a synthesized inorganic-organic polymer hybrid Al(OH)₃-PAM.

13. The charged particle polymer hybrid flocculant of claim 6, wherein the MhPH flocculant is a synthesized inorganic-organic polymer hybrid Fe(OH)₃-PAM.

14. A method for producing freely draining flocculated sediment from a suspension comprising finely divided solids in water, said method comprising the steps of:
a) dispersing, at increasing concentrations, the charged particle polymer hybrid (CPPH) flocculant described in claim 1 into the suspension to determine a starting plateau concentration of CPPH flocculant above which no further increase in the solids content of the flocculated sediment is observed; and
b) maintaining the concentration of dispersed CPPH flocculant in the suspension at or above the starting plateau concentration.

15. The method of claim 14, wherein the flocculated sediment has a minimum permeability of 1 Darcy.

16. The method of claim 14, wherein the flocculated sediment has a minimum permeability of 10 Darcy.

17. The method of claim 14, wherein the charged particle is a sub-micron sized metal-hydroxide particle and the CPPH flocculant is a metal-hydroxide polymer hybrid (MhPH) flocculant.

18. The method of claim 14, wherein the charged particle is a sub-micron sized mixed metal-hydroxide particle and the CPPH flocculant is a mixed metal-hydroxide polymer hybrid flocculant.

19. The method of claim 17, wherein the metal is a transition metal or a metal with multivalence when ionized.

20. The method of claim 17, wherein the metal is aluminum.

21. The method of claim 17, wherein the metal is iron.

22. The method of claim 14, wherein the polymer is polyacrylamide.

23. The method of claim 17, wherein the MhPH flocculant is a synthesized inorganic-organic polymer hybrid Al(OH)₃-PAM.

24. The method of claim 17, wherein the MHP flocculant is a synthesized inorganic-organic polymer hybrid Fe(OH)₃-PAM.

25. The method of claim 14, wherein the concentration of CPPH flocculant dispersed in the suspension is maintained at from 1.2 to 3 times the starting plateau concentration.

26. The method of claim 14, wherein the method is applied to separation processes in one or more industries selected from the group consisting of mining and mineral processing, coal processing, coal-fired power generation, pulp and paper, de-inking, municipal water and wastewater treatment, industrial water and wastewater treatment, food processing, soil cleaning, waste oil recovery in oil and gas processing, treatment of oilsands tailings and treatment of wastewater in oil and gas production and processing.

27. The method of claim 14, wherein dispersion of CPPH flocculant into the suspension is conducted by one or more methods selected from the group consisting of mechanical stirring, mixing, or agitation, injection mixing or induced turbulent flow.

28. A method for separating fine solids and water from a suspension comprising finely divided solids in water, said method comprising the steps of:
a. dispersing, at increasing concentrations, the charged particle polymer hybrid (CPPH) flocculant described in claim 1 into the suspension to determine a starting plateau concentration of CPPH flocculant above which no further increase in the solids content of the flocculated sediment is observed a starting plateau concentration of CPPH flocculant above which a freely draining flocculated sediment is produced that has a minimum permeability of 1 Darcy;
b. maintaining the concentration of dispersed CPPH flocculant in the suspension at or above the starting plateau concentration;
c. agitating the dispersion of CPPH flocculant in the suspension; and
d. separating the solid floccules from the supernatant liquid.

29. The method of claim 28, wherein the flocculated sediment has a minimum permeability of 1 Darcy.

30. The method of claim 28, wherein the flocculated sediment has a minimum permeability of 10 Darcy.

31. The method of claim 28, wherein the charged particle is a sub-micron sized metal-hydroxide particle and the polymer hybrid flocculant is a metal-hydroxide polymer hybrid (MhPH) flocculant.

32. The method of claim 28, wherein the charged particle is a sub-micron sized mixed metal-hydroxide particle and the polymer hybrid flocculant is a mixed metal-hydroxide polymer hybrid flocculant.

33. The method of claim 31, wherein the metal is a transition metal or a metal with multivalence when ionized.

34. The method of claim 31, wherein the metal is aluminum.

35. The method of claim 31, wherein the metal is iron.

36. The method of claim 28, wherein the polymer is polyacrylamide.

37. The method of claim 31, wherein the MHP flocculant is a synthesized inorganic-organic polymer hybrid Al(OH)₃-PAM.

38. The method of claim 31, wherein the MHP flocculant is a synthesized inorganic-organic polymer hybrid Fe(OH)₃-PAM.

39. The method of claim 28, wherein the concentration of CPPH flocculant dispersed in the suspension is maintained at from 1.2 to 3 times the starting plateau concentration.

40. The method of claim 28, wherein the method is applied to separation processes in one or more industries selected from the group consisting of mining and mineral processing, coal processing, coal-fired power generation, pulp and paper, de-inking, municipal water and wastewater treatment, industrial water and wastewater treatment, food processing, soil cleaning, waste oil recovery in oil and gas processing, treatment of oilsands tailings and treatment of wastewater in oil and gas production and processing.

41. The method of claim 28, wherein dispersion of CPPH flocculant into the suspension is conducted by one or more methods selected from the group consisting of mechanical stirring, mixing, or agitation, injection mixing or induced turbulent flow.
